(19) United States
(12) Patent Application Publication
(10) Pub. No.: US 2010/0148468 A1
(43) Pub. Date: Jun. 17, 2010

(54) Bicycle frame

(75) Inventor: Sheng-Hsu Tsai, Budai Township (TW)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: AVANTS INTERNATIONAL CORP., Taipei (TW)

(21) Appl. No.: 12/591,968

(22) Filed: Dec. 4, 2009

(30) Foreign Application Priority Data
Dec. 17, 2008 (TW) 097222651

(51) Int. Cl. B62K 3/04; B05D 1/36

(52) U.S. Cl. 280/281.1; 427/205

(57) ABSTRACT

A bicycle frame includes a frame body, a base coating layer covering an entire surface of the frame body, and a decorative layer thermal bonded to an entire outer surface of the base coating layer. The decorative layer includes an adhesive layer, a patterned layer that is printed on the adhesive layer, and a reflective layer that has a plurality of reflective particles bonded to the adhesive layer. A method of forming the bicycle frame is also disclosed.

### CROSS-REFERENCE TO RELATED APPLICATION

This application claims priority to Taiwanese Application No. 097222651, filed Dec. 17, 2008, the disclosure of which is incorporated herein by reference.

### BACKGROUND OF THE INVENTION

1. Field of the Invention

This invention relates to a bicycle frame, more particularly to a bicycle frame capable of reflecting light.

2. Description of the Related Art

A plurality of conventional light reflective stickers are attached to a bicycle frame of a bicycle so as to reflect light from a vehicle in the night. However, the light reflective stickers have small surface areas, and are consequently unable to efficiently reflect light that is transmitted from a distant vehicle or light that is not directly transmitted thereto. The light reflective stickers are incapable of warning a driver of a vehicle. Furthermore, the light reflective stickers may lose stickiness thereof due to long-term exposure to sun and rain, and may be hence detached from the bicycle frame.

### SUMMARY OF THE INVENTION

The object of the present invention is to provide a bicycle frame that can overcome the aforesaid drawbacks of the prior art.

According to one aspect of this invention, a bicycle frame includes a frame body, a base coating layer covering an entire surface of the frame body, and a decorative layer thermal bonded to an entire outer surface of the base coating layer. The decorative layer includes an adhesive layer, a patterned layer that is printed on the adhesive layer, and a reflective layer that has a plurality of reflective particles bonded to the adhesive layer.

According to another aspect of this invention, a bicycle frame includes a frame body, a base coating layer coated on the frame body, and a decorative layer bonded to the base coating layer. The decorative layer includes a patterned layer, an adhesive layer, and a reflective layer. The bicycle frame is made by a process which includes providing the base coating layer to an outer surface of the frame body, forming the decorative layer on a release substrate, disposing the release substrate together with the decorative layer on the base coating layer, and thermal bonding the decorative layer to the base coating layer.

### BRIEF DESCRIPTION OF THE DRAWINGS

Other features and advantages of the present invention will become apparent in the following detailed description of the preferred embodiment of this invention, with reference to the accompanying drawings, in which:

FIG. 1 is a perspective view of the preferred embodiment of a bicycle frame according to this invention;

FIG. 2 is a fragmentary partly sectional view of the preferred embodiment; and

FIG. 3 is the same view as FIG. 2 but illustrating that a release substrate is removed from a reflective layer.

### DETAILED DESCRIPTION OF THE PREFERRED EMBODIMENT

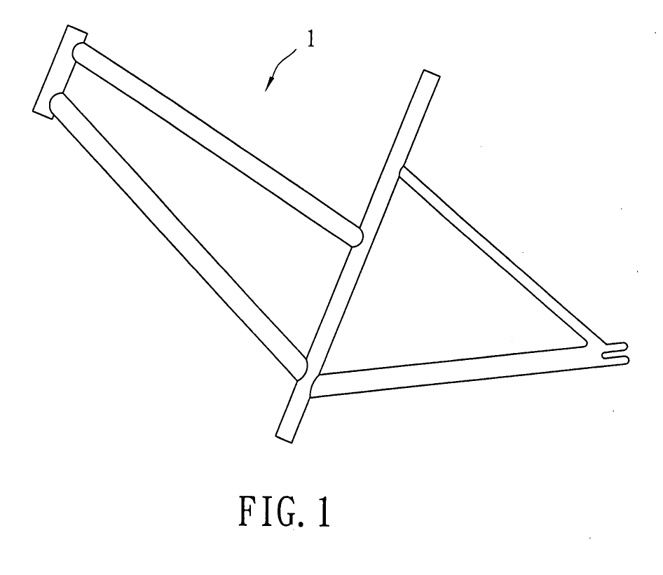

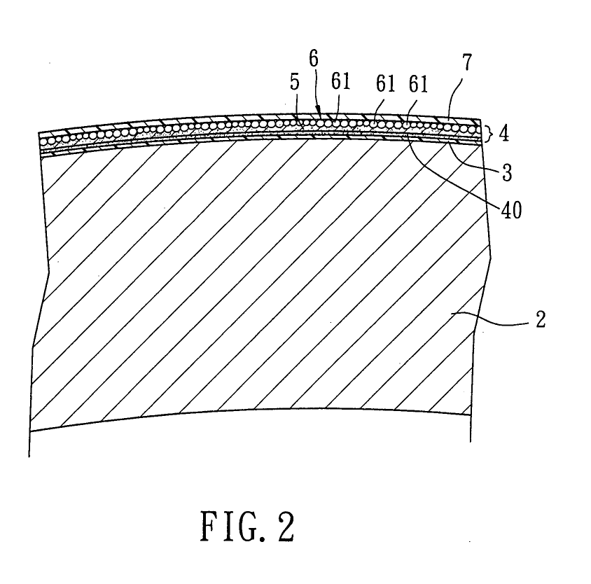

Referring to FIGS. 1, 2, and 3, the preferred embodiment of a bicycle frame 1 according to the present invention includes a frame body 2, a base coating layer 3 that covers an entire surface of the frame body 2, and a decorative layer 4 that is thermal bonded to an entire outer surface of the base coating layer 3. The decorative layer 4 includes an adhesive layer 5, a reflective layer 6 that is bonded to the adhesive layer 5 and that includes a plurality of reflective particles 61, and a patterned layer 40 that is printed on the adhesive layer 5.

The frame body 2 is made from a metallic tubular material in this embodiment. It should be noted that the frame body 2 could be made from a carbon fiber reinforced plastic material in other embodiments. The base coating layer 3 is disposed on an entire outer surface of the frame body 2 through a spray coating process followed by baking. When the base coating layer 3 is heated or baked, the decorative layer 4 can be bonded to the base coating layer 3.

The patterned layer 40 may include a brand logo or other patterns, and can be directly printed and mass produced. The adhesive layer 5 is transparent, and interconnects the patterned layer 40 and the reflective layer 6.

In this embodiment, the reflective particles 61 are tiny glass sands. Alternatively, the reflective particles 61 could be light reflective stone crystal particles or metal particles in other embodiments. The reflective particles 61 are uniformly disposed over the frame body 2 such that light transmitted from any angle to the frame body 2 can be efficiently reflected by the reflective particles 61.

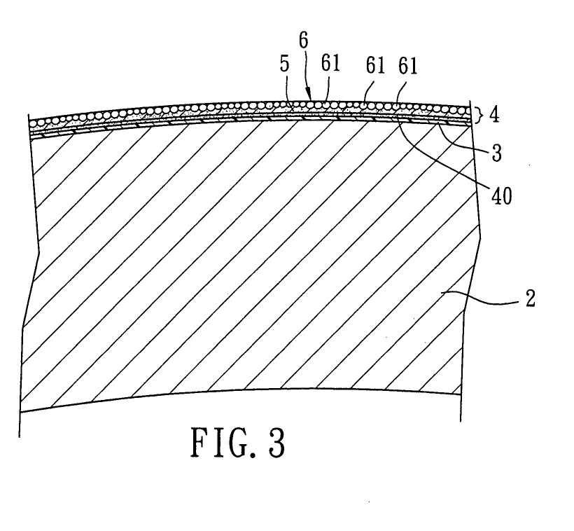

The bicycle frame 1 further includes a release substrate 7 that covers the reflective layer 6. In this embodiment, the release substrate 7 is made from a transparent plastic material. It should be noted that the release substrate 7 could be made from a paper material in other embodiments. The release substrate 7 is able to protect the reflective layer 6 (e.g., to prevent the reflective layer 6 from being scratched) and is removable from the reflective layer 6. The bicycle frame 1 can be assembled with other components to produce a bicycle. When the bicycle is required to be used, the release substrate 7 is preferably removed from the reflective layer 6 so as to expose the same (see FIG. 3). Consequently, the reflective particles 61 can reflect light more efficiently.

A method of making the bicycle frame 1 is described as follows. After the frame body 2 is formed, a base coating is sprayed on the outer surface of the frame body 2 to form the base coating layer 3. The reflective particles 61 are sprayed onto one surface of the release substrate 7, thereby forming the reflective layer 6. An adhesive is sprayed on the reflective layer 6 so as to form the adhesive layer 5. The patterned layer 40 is printed on one surface of the adhesive layer 5 opposite to the reflective layer 6. The decorative layer 4 is thus formed.

Subsequently, the decorative layer 4 is disposed on the base coating layer 3 with the patterned layer 40 being in contact with the outer surface of the base coating layer 3. When the base coating layer 3 is baked at high temperature, the decorative layer 4 is thermal bonded to the outer surface of the base coating layer 3. Pneumatic pressure or hydraulic pressure is used during the process of baking or thermal bonding. The decorative layer 4 is therefore tightly bonded to the entire surface of the frame body 2. During thermal bonding, the base coating layer 3 is melted, and is bonded to the decorative layer 4.

By dint of pneumatic pressure or hydraulic pressure, the decorative layer 4 can be tightly and entirely attached to the frame body 2 in any shape. The decorative layer 4 thermal bonded to the base coating layer 3 can be prevented from being separated from the frame body 2. Accordingly, the reflective layer 6 can also be prevented from being released from the frame body 2.

While the present invention has been described in connection with what is considered the most practical and preferred embodiment, it is understood that this invention is not limited to the disclosed embodiment but is intended to cover various arrangements included within the spirit and scope of the broadest interpretation and equivalent arrangements.

What is claimed is:

1. A bicycle frame comprising:
a frame body;
a base coating layer covering an entire surface of said frame body; and
a decorative layer thermal bonded to an entire outer surface of said base coating layer, and including:
an adhesive layer;
a patterned layer printed on said adhesive layer; and
a reflective layer having a plurality of reflective particles bonded to said adhesive layer.

2. The bicycle frame as claimed in claim 1, further comprising a release substrate covering said reflective layer.

3. The bicycle frame as claimed in claim 1, wherein said reflective particles include glass sands.

4. The bicycle frame as claimed in claim 1, wherein said reflective particles include stone crystal particles.

5. The bicycle frame as claimed in claim 1, wherein said reflective particles include metal particles.

6. A bicycle frame comprising:
a frame body, a base coating layer coated on said frame body, and a decorative layer bonded to said base coating layer, said decorative layer including a patterned layer, an adhesive layer, and a reflective layer, the bicycle frame being made by a process which includes:
providing said base coating layer to an outer surface of said frame body;
forming said decorative layer on a release substrate;
disposing said release substrate together with said decorative layer on said base coating layer; and
thermal bonding said decorative layer to said base coating layer.

7. The bicycle frame of claim 6, wherein said decorative layer is formed by:
spraying said reflective particles onto said release substrate to form said reflective layer;
applying said adhesive layer to said reflective layer; and
printing said patterned layer on said adhesive layer.

8. The bicycle frame of claim 7, wherein said adhesive layer is applied by spraying.

9. The bicycle frame of claim 6, wherein said patterned layer is in contact with said base coating layer when said decorative layer is disposed on said base coating layer.
